(19) United States
(12) Patent Application Publication
(10) Pub. No.: US 2003/0100663 A1
(43) Pub. Date: May 29, 2003

(54) Aqueous aerosol paints

(76) Inventors: Heinz-Peter Rink, Munster (DE); Werner-Alfons Jung, Ascheberg (DE); Guido Wilke, Munster (DE); Dieter Weber, Overath (DE); Hans-Joachim Weintz, Senden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/182,593

(22) PCT Filed: Feb. 8, 2001
(86) PCT No.: PCT/EP01/01342

(30) Foreign Application Priority Data
Mar. 3, 2000 (DE) 100 10 417.7

(51) Int. Cl. C08L 33/06; C08K 3/00

(52) U.S. Cl. 524/507; 524/555; 524/560

(57) ABSTRACT

An aqueous spray can coating material comprising at least one water-soluble or water-dispersible copolymer of ethylenically unsaturated monomers, said copolymer being preparable by an at least two-stage free-radical copolymerization, initiated by oil-soluble thermolabile free-radical initiators, in at least one organic solvent, of (A) at least one ethylenically unsaturated monomer containing at least one hydrophilic functional group (a) which renders the copolymer water-soluble or water-dispersible, and (B)at least one ethylenically unsaturated monomer containing no functional group (a), where, in at least one stage, the monomer (A) employed therein or the monomer mixture (A/B) employed therein would per se form a water-soluble or water-dispersible polymer or copolymer, and its use to coat primed and unprimed substrates.

The present invention relates to novel aqueous spray can coating materials. The present invention further relates to the use of the novel aqueous spray can coating materials to produce coatings.

Spray can painting is a variant of spray painting that is used primarily in the home improvement/craft sector. Spray can painting is used to apply wood preservative coatings, architectural coatings, and automotive refinish coatings, primarily for small objects and relatively small touch-up repairs. It may be used to produce even complete paint systems ranging from different primers and primer-surfacers through to single-coat or two-coat topcoats, including metallic effect coatings.

The spray can coating materials which have been and are commonly employed here are conventional spray can coating materials (aerosol sprays, aerosol coating materials), i.e., are in solution in organic solvents. For reasons of environmental protection and workplace safety, however, manufacturers and users are endeavoring to use aqueous spray can coating materials. Such materials, however, impose new requirements on the water-soluble or water-dispersible binders, in order that the aqueous spray can coating materials match or exceed the performance properties of the conventional spray can coating materials, especially with regard to rapid drying and storage stability.

The European patent EP 0 693 540 A2 discloses rapidly drying aqueous spray can coating materials which give high-gloss coatings. A disadvantage of these known aqueous spray can coating materials is that the solid thermoplastic polyacrylate resins they comprise must first be solubilized with alcohols and then diluted with water again. In order to achieve a high gloss, moreover, it is necessary to add water-soluble or water-dispersible polyacrylate resins with a mass-average molecular weight of from 20,000 to 200,000, an acid number of from 30 to 160, and a glass transition temperature of from 30 to 140° C. To obtain adequate storage stability, comparatively high solvent contents and/or the use of low molecular mass emulsifiers are necessary. Where the water-soluble or water-dispersible polyacrylate resins are the sole binders used, the resulting spray can coating materials will give coatings having markedly poorer properties, as demonstrated in the European patent EP 0 693 540 A2 by comparative tests (cf. especially page 6, table 5 in conjunction with page 7, table 7).

It is an object of the present invention to provide novel aqueous spray can coating materials which no longer have the disadvantages of the prior art but which instead, even without the use of low molecular mass emulsifiers and/or high solvent contents, are storage-stable and give flat to high-gloss coatings.

The invention accordingly provides the novel aqueous spray can coating material comprising at least one water-soluble or water-dispersible copolymer of ethylenically unsaturated monomers, said copolymer being preparable by an at least two-stage free-radical copolymerization, initiated by oil-soluble thermolabile free-radical initiators, in at least one organic solvent, of

(A) at least one ethylenically unsaturated monomer containing at least one hydrophilic functional group (a) which renders the copolymer water-soluble or water-dispersible, and

(B) at least one ethylenically unsaturated monomer containing no functional group (a),

where, in at least one stage, the monomer (A) employed therein or the monomer mixture (A/B) employed therein would per se form a water-soluble or water-dispersible polymer or copolymer.

In the text below, the novel spray can coating material is referred to as the “spray can coating material of the invention”.

Further subject matter of the invention will emerge from the description.

In the light of the prior art it was surprising and unforeseeable for the skilled worker that the object on which the present invention is based would be achievable through the inventive use in the spray can coating materials of the invention of a water-soluble or water-dispersible copolymer of ethylenically unsaturated monomers (A) and (B) that has been prepared in a multistage procedure. A particular surprise was that, even without the use of low molecular mass emulsifiers and/or high organic solvent contents, the spray can coating materials of the invention are storage-stable and give matt to high-gloss coatings.

The key inventive constituent of the spray can coating material of the invention is the water-soluble or water-dispersible copolymer of ethylenically unsaturated monomers.

In accordance with the invention, the copolymer is prepared by an at least two-stage copolymerization. At the upper end, the number of stages is limited essentially only by economic considerations. Thus the skilled worker will restrict the number of stages to the level needed to achieve the technical effect of the invention, so as not to prolong the reaction times without achieving significant additional advantages. Generally speaking, five stages are sufficient to achieve the advantages of the invention. It is preferred to employ four stages, with particular preference three stages.

The copolymerization is initiated by oil-soluble thermolabile free-radical initiators. Examples of suitable initiators for use in accordance with the invention are dialkyl peroxides, such as di-tert-butyl peroxide, di-tert-amyl peroxide or dicumyl peroxide; hydroperoxides, such as cumene hydroperoxide or tert-butyl hydroperoxide; peresters, such as tert-butyl perbenzoate, tert-butyl perpivalate, tert-butyl per-3,5,5-trimethylhexanoate, tert-butyl peroxyneodecanoate or tert-butyl per-2-ethylhexanoate; diacyl peroxides such as dibenzoyl peroxide; peroxodicarbonates; azo initiators such as azobisisobutyronitrile; or C-C-cleaving initiators such as benzpinacol silyl ethers. It is also possible to use combinations of the above-described initiators.

The amount of the initiator may vary very widely and is guided by the requirements of the case in hand. In accordance with the invention it is of advantage to use from 0.1 to 20, preferably from 0.5 to 18, with particular preference from 1.0 to 17, with very particular preference from 1.5 to 16, and in particular from 2 to 15% by weight, based in each case on the amount of initiator and monomers (A) and (B).

In accordance with the invention, the free-radical copolymerization is conducted in at least one organic solvent. It is preferred here to use water-soluble or water-dispersible organic solvents. Examples of suitable solvents are low molecular mass alcohols such as ethanol, propanol, isopropanol, n-butanol, sec-butanol or tert-butanol, or low molecular mass ether alcohols such as ethoxypropanol, methoxypropanol or propoxypropanol. The organic solvents may also include small fractions of higher-boiling alcohols or ether alcohols, provided they do not negatively impact the drying of the spray can coating material of the invention. Examples of suitable higher-boiling alcohols are diethylocatanediols such as 2,4-diethyl-1,5-octanediol.

The organic solvents are preferably used in an amount such that the resulting copolymer solutions have a solids content of from 50 to 90, preferably from 55 to 85, with particular preference from 60 to 80, and in particular from 65 to 75% by weight, based in each case on the solution.

The copolymers for use in accordance with the invention are prepared from at least one ethylenically unsaturated monomer (A) containing at least one, preferably one, hydrophilic functional group (a) which renders the copolymer water-soluble or water-dispersible.

In the context of the present invention, hydrophilicity is the constitutional property of a molecule or functional group to penetrate the aqueous phase or to remain therein. For further details, reference is made to Römpp Lexikon Lacke und Druckfarben, Georg Thieme Verlag, Stuttgart, New York 1998, “hydrophilicity”, “hydrophobicity”, pages 294 and 295.

Examples of suitable functional groups (a) are functional groups (a1) which can be converted into cations by neutralizing agents and/or quaternizing agents, and/or cationic groups; functional groups (a2) which can be converted into anions by neutralizing agents, and/or anionic groups; or nonionic hydrophilic groups (a3).

Examples of suitable functional groups (a1) for use in accordance with the invention, which can be converted into cations by neutralizing agents and/or quaternizing agents, are primary, secondary or tertiary amino groups, secondary sulfide groups or tertiary phosphine groups, preferably amino groups or secondary sulfide groups, especially the amino groups.

Examples of suitable cationic groups (a1) for use in accordance with the invention are primary, secondary, tertiary or quaternary ammonium groups, tertiary sulfonium groups or quaternary phosphonium groups, preferably the ammonium groups or tertiary sulfonium groups, but especially the ammonium group.

Examples of suitable functional groups (a2) for use in accordance with the invention which can be converted into anions by neutralizing agents are carboxylic, sulfonic or phosphonic acid groups, especially carboxylic acid groups.

Examples of suitable anionic groups (a2) for use in accordance with the invention are carboxylate, sulfonate or phosphonate groups, especially carboxylate groups.

Examples of suitable nonionic groups (a3) for use in accordance with the invention are poly(alkylene ether) groups such as methoxy-, ethoxy-, propyloxy- or butyloxy-polyethylene glycol, -polypropylene glycol or -polypropylene-polyethylene glycol, with random or block distribution of the monomer units. The poly(alkylene ether) groups preferably have a degree of polymerization of from 3.0 to 500.

Examples of suitable neutralizing agents for functional groups (a1) convertible into cations are organic and inorganic acids such as formic acid, acetic acid, lactic acid, dimethylolpropionic acid, citric acid, sulfuric acid, hydrochloric acid, and phosphoric acid.

Examples of suitable neutralizing agents for functional groups (a2) convertible into anions are ammonia, ammonium salts, such as ammonium carbonate or ammonium bicarbonate, for example, and also amines, such as trimethylamine, triethylamine, tributylamine, dimethylaniline, diethylaniline, triphenylamine, dimethylethanolamine, diethylethanolamine, methyldiethanolamine, triethanolamine and the like. A preferred neutralizing agent used is ammonia.

The overall amount of neutralizing agents used is chosen so that from 1 to 100 equivalents, preferably from 50 to 90 equivalents, of the functional groups (a1) or (a2) of the copolymer for use in accordance with the invention are neutralized. The neutralizing agents are preferably added to the copolymer solution following copolymerization.

Obviously, monomers (A) containing functional groups (a1) or (a2) may be employed together with monomers (A) containing functional groups (a3). In contrast, the use of monomers (A) containing functional groups (a1) together with monomers (A) containing functional groups (a2) is disadvantageous in the great majority of cases, since it entails the risk that ionic complexes will be precipitated.

Of the functional (potentially) ionic groups (a1) and (a2) and functional nonionic groups (a3), the (potentially) anionic groups (a2) are advantageous and are therefore used with particular preference.

Examples of suitable ethylenically unsaturated monomers (A) are ethylenically unsaturated amines such as aminoethyl acrylate, N-methylaminoethyl acrylate, N,N-dimethylaminoethyl acrylate or N,N-diethylaminoethyl acrylate or the corresponding methacrylates, N,N-diethylaminostyrene (all isomers), N,N-diethylamino-alpha-methylstyrene (all isomers), allylamine, crotylamine, vinylidene-bis(4-N,N-dimethylaminobenzene) or vinylidene-bis(4-aminobenzene); ethylenically unsaturated acids such as acrylic acid, methacrylic acid, ethacrylic acid, crotonic acid, maleic acid, fumaric acid, itaconic acid or alpha-methylvinylbenzoic acid (all isomers), ethylenically unsaturated sulfonic or phosphonic acids or their partial esters, such as p-vinylbenzenesulfonic acid or -phosphonic acid or mono(meth)acryloyloxyethyl maleate, succinate or phthalate; or ethylenically unsaturated poly(alkylene ethers) such as methoxy-, ethoxy-, propyloxy- or butyloxy-polyethylene glycol, -polypropylene glycol or -polypropylene-polyethylene glycol acrylate or methacrylate, in which the poly(alkylene ether) groups preferably have a degree of polymerization of from 3.0 to 500.

In accordance with the invention, the ethylenically unsaturated monomers (A) are copolymerized with at least one monomer (B) which contains no functional groups (a).

Examples of suitable ethylenically unsaturated monomers (B) for use in accordance with the invention are

b1) (meth)acrylic esters substantially free from acid groups, such as (meth)acrylic alkyl or cycloalkyl esters having up to 20 carbon atoms in the alkyl radical, especially methyl, ethyl, propyl, n-butyl, sec-butyl, tert-butyl, hexyl, ethylhexyl, stearyl and lauryl acrylate or methacrylate; cycloaliphatic (meth)acrylic esters, especially cyclohexyl, isobornyl, dicyclopentadienyl, octahydro-4,7-methano-1H-indenemethanol or tertbutylcyclohexyl (meth)acrylate. In minor amounts, these monomers may include (meth)acrylic alkyl or cycloalkyl esters of higher functionality, such as ethylene glycol, propylene glycol, diethylene glycol, dipropylene glycol, butylene glycol, pentane-1,5-diol, hexane-1,6-diol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate. In the context of the present invention, minor amounts of monomers of higher functionality are those amounts which do not lead to crosslinking or gelling of the copolymers.

b2) Monomers which carry at least one hydroxyl group per molecule and are substantially free from acid groups, such as hydroxyalkyl esters of acrylic acid, methacrylic acid or another alpha,beta-olefinically unsaturated carboxylic acid, which derive from an alkylene glycol which is esterified with the acid, or which are obtainable by reacting the alpha,beta-olefinically unsaturated carboxylic acid with an alkylene oxide, especially hydroxyalkyl esters of acrylic acid, methacrylic acid, ethacrylic acid or crotonic acid in which the hydroxyalkyl group contains up to 20 carbon atoms, such as 2-hydroxyethyl, 2-hydroxypropyl, 3-hydroxypropyl, 3-hydroxybutyl, 4-hydroxybutyl acrylate, methacrylate, ethacrylate or crotonate; or hydroxycycloalkyl esters such as 1,4-bis(hydroxymethyl)cyclohexane, octahydro-4,7-methano-1H-indenedimethanol or methylpropanediol monoacrylate, monomethacrylate, monoethacrylate, monocrotonate, monomaleate, monofumarate or monoitaconate; or reaction products of cyclic esters, such as epsilon-caprolactone, for example, and these hydroxyalkyl or hydroxycycloalkyl esters; or olefinically unsaturated alcohols such as allyl alcohol or polyols such as trimethylolpropane monoallyl or diallyl ether or pentaerythritol monoallyl, diallyl or triallyl ether (with regard to these monomers (b2) of higher functionality, the comments made above regarding the monomers (a1) of higher functionality apply analogously).

b3) Vinyl esters of alpha-branched monocarboxylic. acids having 5 to 18 carbon atoms in the molecule. The branched monocarboxylic acids may be obtained by reacting formic acid or carbon monoxide and water with olefins in the presence of a liquid, strongly acidic catalyst; the olefins may be cracking products of paraffinic hydrocarbons, such as mineral oil fractions, and may comprise both branched and straight-chain acyclic and/or cycloaliphatic olefins. The reaction of such olefins with formic acid or with carbon monoxide and water produces a mixture of carboxylic acids in which the carboxyl groups are located predominantly on a quaternary carbon atom. Other olefinic starting materials are, for example, propylene trimer, propylene tertramer, and diisobutylene. Alternatively, the vinyl esters (b3) may be prepared from the acids in a conventional manner, by reacting the acid with acetylene, for example. Particular preference—owing to their ready availability—is given to the use of vinyl esters of saturated aliphatic monocarboxylic acids having 9 to 11 carbon atoms that are branched on the alpha carbon atom, but especially Versatic® acids (cf. Römpp, op. cit., “Versatic® acids”, pages 605 and 606).

b4) Reaction products of acrylic acid and/or methacrylic acid with the glycidyl ester of an alpha-branched monocarboxylic acid having 5 to 18 carbon atoms per molecule, especially a Versatic® acid, or, instead of the reaction product, an equivalent amount of acrylic and/or methacrylic acid which is then reacted, during or after the polymerization reaction, with the glycidyl ester of an alpha-branched monocarboxylic acid having 5 to 18 carbon atoms per molecule, especially a Versatic® acid.

b5) Cyclic and/or acyclic olefins such as ethylene, propylene, but-1-ene, pent-1-ene, hex-1-ene, cyclohexene, cyclopentene, norbornene, butadiene, isoprene, cyclopentadiene and/or dicyclopentadiene.

b6) (Meth)acrylamides such as (meth)acrylamide, N-methyl-, N,N-dimethyl-, N-ethyl-, N,N-diethyl-, N-propyl-, N,N-dipropyl-, N-butyl-, N,N-dibutyl-, N-cyclohexyl-, N,N-cyclohexylmethyl- and/or N-methylol-, N,N-dimethylol-, N-methoxymethyl-, N,N-di(methoxymethyl)-, N-ethoxymethyl- and/or N,N-di(ethoxyethyl)-(meth)acrylamide;

b7) Monomers containing epoxide groups, such as the glycidyl ester of acrylic acid, methacrylic acid, ethacrylic acid, crotonic acid, maleic acid, fumaric acid and/or itaconic acid.

b8) Monomers containing isocyanate groups, such as 1-(1-isocyanato-1-methylethyl)-3-(1-methylethenyl)benzene (TMI® from CYTEC), vinyl isocyanate or allyl isocyanate.

b9) Vinylaromatic hydrocarbons such as styrene, alpha-alkylstyrenes, especially alpha-methylstyrene, or vinyltoluene;

b10) Nitriles such as acrylonitrile and/or methacrylonitrile.

b11) Vinyl compounds, especially vinyl halides and/or vinylidene dihalides such as vinyl chloride, vinyl fluoride, vinylidene dichloride or vinylidene difluoride; N-vinyl amides such as vinyl-N-methylformamide, N-vinylcaprolactam, 1-vinylimidazole or N-vinylpyrrolidone; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.

b12) Allyl compounds, especially allyl ethers and allyl esters such as allyl methyl, ethyl, propyl or butyl ether or allyl acetate, propionate or butyrate.

b13) Polysiloxane macromonomers which have a number-average molecular weight Mn of from 1000 to 40,000 and contain on average from 0.5 to 2.5 ethylenically unsaturated double bonds per molecule; especially polysiloxane macromonomers which have a number-average molecular weight Mn of from 2000 to 20,000, with particular preference from 2500 to 10,000, and in particular from 3000 to 7000, and contain on average from 0.5 to 2.5, preferably from 0.5 to 1.5, ethylenically unsaturated double bonds per molecule, as are described in DE 38 07 517 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1, or in the international patent application WO 92/22615 on page 12 line 18 through page 18 line 10

b14) Acryloxysilane-containing vinyl monomers, preparable by reacting hydroxy-functional silanes with epichlorohydrin and then reacting that reaction product with (meth)acrylic acid and/or hydroxyalkyl and/or hydroxycycloalkyl esters of (meth)acrylic acid (cf. monomers b2).

In accordance with the invention, the monomers (b1), (b2) and (b3) are of advantage and are therefore used with preference.

In accordance with the invention it is also of advantage to select the monomers (A) and (B) such that the resulting copolymer is substantially determined in its properties by the acrylates and methacrylates.

For the copolymer for use in accordance with the invention, it is important that in at least one stage, preferably in one stage, the monomer (A) employed therein or the monomer mixture (A/B) employed therein would per se form a water-soluble or water-dispersible polymer or copolymer. On the basis of his or her general knowledge in the art, possibly supplemented by the assistance of simple rangefinding tests, the skilled worker is easily able to determine the ratio of the monomers (A) and (B) in the monomer mixture that would lead to solubility or dispersibility in water and also to determine the amount of monomers (A) overall which renders the copolymers soluble or dispersible in water. Regarding the general knowledge in the art, reference is made to Römpp, op. cit., “waterborne coating materials” to “water-solubility”, pages 624 and 625.

This “water-soluble stage” forms the first or the last stage of the at least two-stage copolymerization. The variant to which preference is given depends on the requirements of the case in hand and may be determined on the basis of the general knowledge in the art, possibly with the assistance of simple preliminary tests.

In accordance with the invention it is of advantage if, in at least one stage, the monomer (A) or (B) employed therein or the monomer mixture (A/B) employed therein would form a polymer or copolymer having a glass transition temperature according to Fox of 30° C. or less.

The glass transition temperature of acrylic copolymers is determined, as is known, by the nature and amount of the monomers used. The skilled worker is able to select the monomers with the assistance of the following formula of Fox, in accordance with which it is possible to make an approximate calculation of the glass transition temperatures.

$$1 / Tg = {\sum }_{n = 1}^{n = x} {W}_{n} / {Tg}_{n} ; {\sum }_{n} {W}_{n} = 1 ;$$

Tg=glass transition temperature of the polyacrylate resin

Wₙ=weight fraction of the nth monomer

Tgₙ=glass transition temperature of the homopolymer of the nth monomer

x=number of different monomers

Further advantages result if the monomers (A) and (B) are selected such that in their theoretical sum they would give rise to a glass transition temperature according to Fox of 30° C. or less.

The molecular weight of the copolymers for use in accordance with the invention may vary widely. The copolymer preferably has a number-average molecular weight of from 5000 to 100,000, more preferably from 6000 to 50,000, with particular preference from 7000 to 40,000, with very particular preference from 8000 to 35,000, and in particular from 9000 to 30,000 daltons. Further advantages result if the mass-average molecular weight is from 10,000 to 500,000, more preferably from 11,000 to 300,000, with particular preference from 12,000 to 200,000, with very particular preference from 13,000 to 100,000, and in particular from 14,000 to 80,000 daltons.

Besides the constituents described above, the organic solution in which the free-radical copolymerization is conducted may also comprise further suitable substances.

Examples of suitable substances are molecular weight regulators such as mercaptoethanol, dodecyl mercaptan, square-planar cobalt complexes, captodative compounds, or compounds which exert control in accordance with the initiator transfer termination mechanism, such as tetraethylthiuram or the tetramethylpiperidyl radical. These compounds may be present in the organic solution right from the start or may be added at certain times and/or stages of the free-radical copolymerization.

The organic solution may further comprise polymerizable and/or nonpolymerizable, water-soluble and/or water-insoluble oligomers and polymers. In the context of the present invention, oligomers are resins containing at least 2 to 15 repeating monomer units in their molecule. In the context of the present invention, polymers are resins containing at least 10 repeating monomer units in their molecule. For further details of these terms, reference is made to Römpp, op. cit., “oligomers”, page 425.

Examples of suitable resins are random, alternating and/or block, linear and/or branched and/or comb, addition (co)polymers of ethylenically unsaturated monomers, examples being those described above, or polyaddition resins and/or polycondensation resins. For further details of these terms, reference is made to Römpp op. cit., page 457, “polyaddition” and “polyaddition resins (polyadducts)”, and also pages 463 and 464, “polycondensates”, “polycondensation” and “polycondensation resins”.

Furthermore, the copolymers may be modified, during and/or after the copolymerization, with mono-, di- and/or polyisocyanates, -carboxylic acids and/or -epoxides. In the case of modification it must be ensured that the water-solubility or water-dispersibility of the copolymers is not lost.

Viewed in terms of its methodology, the free-radical copolymerization has no special features, but may instead be carried out in the apparatus conventional in this field, especially in stirred vessels, tube reactors, loop reactors or Taylor reactors, and also, if desired, under pressure, especially when using relatively high temperatures and/or readily volatile monomers (A) and/or (B), the Taylor reactors being configured such that the conditions of Taylor flow are met over the entire reactor length, even if the kinematic viscosity of the reaction medium changes greatly (in particular, increases) owing to the copolymerization.

The amount of copolymer for inventive use in the spray can coating material of the invention may vary very widely and is guided by the respective intended use and by the other constituents present therein. The amount is preferably from 5.0 to 70, more preferably from 6.0 to 65, with particular preference from 7.0 to 60, with very particular preference from 8.0 to 55, and in particular from 9.0 to 50% by weight, based in each case on the spray can coating material of the invention.

The spray can coating material of the invention preferably comprises water and organic solvents in the amounts known from the prior art. By way of example, reference is made to the European patent EP 0 693 540 A2.

In addition, the spray can coating material of the invention may comprise customary and known pigments. Examples of suitable pigments are known from Römpp, op. cit., page 176: “effect pigments”, pages 380 and 381: “metal oxide-mica pigments” to “metal pigments”, pages 180 and 181: “iron blue pigments” to “black iron oxide”, pages 451 to 453: “pigments” to “pigment volume concentration”, page 563: “thioindigo pigments” and page 567: “titanium dioxide pigments”.

The spray can coating material of the invention may further comprise customary and known waterborne coatings additives. Examples of suitable waterborne coatings additives are known from Römpp, op. cit., pages 623 and 624: “waterborne coatings additives” or from the European patent EP 0 693 540 A2, page 5, lines 6 to 10. They are preferably used in the amounts specified therein.

The spray can coating material of the invention may be applied using the customary and known propellants. Examples of suitable propellants are low-boiling liquids such as dimethyl ether, aliphatic hydrocarbons, chlorofluorinated hydrocarbons, fluorinated hydrocarbons, but especially dimethyl ether. In addition, gaseous propellants such as nitrogen, carbon dioxide or laughing gas may also be used.

The spray can coating material of the invention is used to coat primed and unprimed substrates.

Suitable coating substrates include all surfaces; that is, for example, metals, plastics, wood, ceramic, stone, textile, fiber composites, leather, glass, glass fibers, glass wool, rock wool, mineral-bound and resin-bound building materials, such as plasterboard and cement slabs or roof tiles, and also composites of these materials. Accordingly, the spray can coating material of the invention is also suitable for application outside of automotive finishing. In this context it is particularly suitable for the coating of furniture and for industrial coating, including coil coating, container coating and the impregnation or coating of electrical components. In the context of industrial coatings it is suitable for coating virtually all parts for private or industrial use, such as radiators, domestic appliances, small metal parts such as nuts and bolts, hub caps, wheel rims, packaging, or electrical components such as motor windings or transformer windings.

In the case of electrically conductive substrates, it is possible to use primers produced in a customary and known manner from electrodeposition coating materials. Both anodic and cathodic electrodeposition coating materials may be used for this purpose, but especially cathodic.

Using the spray can coating material of the invention it is also possible to coat primed or unprimed plastics such as, for example, ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations to DIN 7728T1). The plastics to be coated may of course also comprise polymer blends, modified plastics, or fiber-reinforced plastics. It is also possible to employ the plastics which are commonly used in vehicle construction, especially motor vehicle construction. Unfunctionalized and/or nonpolar substrate surfaces may be subjected prior to coating in a known manner to a pretreatment, such as with a plasma or by flaming, or may be provided with a water-based primer.

On the basis of its advantageous technical properties, it may also be used to coat particularly sensitive substrates such as art works or antiques.

Particular advantages result in this case if the spray can coating material of the invention is employed over small areas, such as for repair purposes, for example.

The coatings of the invention that are produced from the spray can coating material of the invention adhere very firmly to the primed and unprimed substrates. They are hard, flexible, resistant to solvent, water and alkali, and range from flat to high gloss.

### EXAMPLE

### Preparation of a Copolymer for Inventive Use and of an Inventive Spray Can Coating Material

A 4 l steel reactor suitable for free-radical polymerization and equipped with stirrer, reflux condenser and feed vessels was charged with 583 parts by weight of propanol, and this initial charge was heated to 95°C. Over the course of 5 minutes, a mixture of 2.2 parts by weight of a commercial free-radical initiator (Trigonox® 421) and 13 parts by weight of propanol was metered into the initial charge.

In the first stage, a mixture of 83.2 parts by weight of acrylic acid, 42 parts by weight of styrene and 290 parts by weight of butyl acrylate, added over two hours, and 3.5% of a mixture of 181 parts by weight of Trigonox® 421 and 181 parts by weight of propanol, added over 30 minutes, were metered in at a uniform rate, commencing simultaneously. Subsequently, the resulting reaction mixture was heated at 95° C. with stirring for 20 minutes more.

In the second stage, a mixture of 86.2 parts by weight of styrene and 115 parts by weight of butyl acrylate, added over two hours, and 6.2% of the above-described initiator solution, added over one hour, were metered into the reaction mixture at a uniform rate, commencing simultaneously. Subsequently, the resulting reaction mixture was heated at 95° C. with stirring for 60 minutes more.

In the third stage, a mixture of 180 parts by weight of methyl methacrylate, 315 parts by weight of styrene and 495 parts by weight of butyl acrylate, added over four hours, and 48.1% of the above-described initiator solution, added over four hours, were metered into the reaction mixture at a uniform rate, commencing simultaneously. Finally, 42.2% of the initiator solution was metered in at a uniform rate over the course of two hours. Thereafter, the resulting reaction mixture was held at 95°0 C. for 1.5 hours.

The resulting copolymer solution had a solids content of 70.6% by weight (2 g initial weight taken+2 g xylene/one hour/130° C.). The copolymer had a number-average molecular weight of 15,981 and a mass-average molecular weight of 53,316 and also an acid number of 41.8 mg KOH/g.

The copolymer solution was adjusted to a solids content of 37% by weight using 75.6 parts by weight of 25 percent strength ammonia solution.

The resulting aqueous copolymer solution was outstandingly suitable for the preparation of spray can coating materials. For this purpose, it was adjusted to the desired spray viscosity with water and, in a spray can, was admixed with dimethyl ether as propellant. The spray can coating material proved to be extremely stable on storage, even without the addition of low molecular mass emulsifiers. The spray can coating material was sprayed onto the surface of glass plates where it gave rapidly drying, hard, firmly adhering, high-gloss, alkali-resistant coatings.

What is claimed is:

1. An aqueous spray can coating material comprising at least one water-soluble or water-dispersible copolymer of ethylenically unsaturated monomers, said copolymer being preparable by an at least two-stage free-radical copolymerization, initiated by oil-soluble thermolabile free-radical initiators, in at least one organic solvent, of
(A) at least one ethylenically unsaturated monomer containing at least one hydrophilic functional group (a) which renders the copolymer water-soluble or water-dispersible, and
(B) at least one ethylenically unsaturated monomer containing no functional group (a),
where, in at least one stage, the monomer (A) employed therein or the monomer mixture (A/B) employed therein would per se form a water-soluble or water-dispersible polymer or copolymer.

2. The coating material as claimed in claim 1, wherein the copolymer has a number-average molecular weight of from 5000 to 100,000 daltons and a mass-average molecular weight of from 10,000 to 500,000 daltons.

3. The coating material as claimed in claim 1 or 2, wherein the stage in which the monomer (A) employed therein or the monomer mixture (A/B) employed therein would per se form a water-soluble or water-dispersible polymer or copolymer constitutes the first or the last stage of the at least two-stage copolymerization.

4. The coating material as claimed in any of claims 1 to 3, wherein the multistage copolymerization encompasses up to five stages.

5. The coating material as claimed in any of claims 1 to 4, wherein, in at least one stage, the monomer (A) or (B) employed therein or the monomer mixture (A/B) employed therein would form a polymer or copolymer having a glass transition temperature according to Fox of 30° C. or less.

6. The coating material as claimed in any of claims 1 to 5, wherein the monomers (A) and (B) are selected such that in their theoretical sum they would give rise to a glass transition temperature according to Fox of 30° C. or less.

7. The coating material as claimed in any of claims 1 to 6, wherein the monomer (A) comprises as functional group(s) (a)
(a1) functional groups which can be converted into cations by neutralizing agents and/or quaternizing agents, and/or cationic groups,
or
(a2) functional groups which can be converted into anions by neutralizing agents, and/or anionic groups,
and/or
(a3) nonionic hydrophilic groups.

8. The coating material as claimed in claim 7, wherein the functional groups (a1) are carboxylic acid groups or carboxylate groups, the functional groups (a2) are amino groups or ammonium groups, and the functional groups (a3) are polyalkylene ether groups.

9. The coating material as claimed in any of claims 1 to 8, wherein the copolymers are modified during and/or after the copolymerization, with mono-, di- and/or polyisocyanates, -carboxylic acids and/or -epoxides.

10. The coating material as claimed in any of claims 1 to 9, comprising at least one propellant.

11. The coating material as claimed in any of claims 1 to 10, comprising at least one additive.
